(19) United States
(12) Patent Application Publication
(10) Pub. No.: US 2018/0285092 A1
(43) Pub. Date: Oct. 4, 2018

(54) SOFTWARE UPDATE INTERVENTION AS A SERVICE FOR INDUSTRIAL CONTROL SYSTEMS

(71) Applicant: Achutha Narayana Raman, Sherborn, MA (US)

(72) Inventor: Achutha Narayana Raman, Sherborn, MA (US)

(21) Appl. No.: 15/924,237

(22) Filed: Mar. 18, 2018

Related U.S. Application Data
(60) Provisional application No. 62/478,242, filed on Mar. 29, 2017.

(51) Int. Cl. G06F 8/65; G06F 8/71

(52) U.S. Cl. CPC G06F 8/65; G06F 15/18; G06F 8/71

(57) ABSTRACT

A network device receives operational behavior data from industrial control system components on a network. The network device generates, based on the operational behavior data, a contextual intervention model for determining aberrant software updates through a calculated score of impact. The network device also continues to receive data from the industrial control system components to determine ongoing aberrant behavior and decide on intervention.

### RELATED APPLICATIONS

This application claims the benefit of U.S. Provisional Application No. 62/478,242, titled “SOFTWARE UPDATE IMPACT AS A SERVICE FOR INDUSTRIAL CONTROL SYSTEMS, filed Mar. 29, 2017.

### BACKGROUND

Internet connectivity of traditionally closed systems such as Industrial Control Systems (ICS) and their networked devices has introduced new benefits and corresponding risks for the use of these systems in critical infrastructure service support. A key benefit is that the ICS operator can schedule Original Equipment Manufacturer (OEM) software updates to remediate glitches within the device firmware, add new application features, and upgrade the field devices remotely and wirelessly without physically accessing each device. The key risk, however, is that the new update will have an unexpected impact on the continuing operation of the ICS and its connected network.

ICS are typically used in industries such as electric, water and wastewater, oil and natural gas, transportation, chemical, pharmaceutical, pulp and paper, food and beverage, and discrete manufacturing (e.g., automotive, aerospace, and durable goods). ICS components include supervisory control and data acquisition (SCADA) systems, distributed control systems (DCS), and other control system configurations such as skid-mounted Programmable Logic Controllers (PLC) and building automation and control systems (BACS). The ICS domain incorporates physical devices with interfaces to the digital world through which one can gather information and control those devices as well as other objects. The ICS and constituent domain components will jointly be referred to herein as “industrial things.”

Typically for industrial things, update intervention services and real-time context-processing services rely on the detection of network and protocol level anomalies. This may stem, for example, from device-to-device communications data (e.g., identity of “top talkers” and the devices generating the most traffic); captured traffic data (e.g., function codes and control parameters observed); behavioral data; hierarchy, taxonomy, and organization of network traffic information; and more. Unfortunately, traditional approaches provide no convenient way by which ICS operators can rely on an external scoring service to render a score of impact associated with an OEM update to predict the operational intervention required in critical infrastructures.

Based on the foregoing, there is a need for enabling intervention categories to be associated with industrial things and scored by an external scoring service to determine the expected level of impact from an ICS operator's OEM update. The present invention is directed at resolving this need.

### BRIEF SUMMARY OF THE INVENTION

Systems and/or methods provided herein may produce a contextual intervention model for determining an aberrant software update in industrial control system components on a network. The contextual intervention model may include a classification model trained, by machine learning, on operational behavior data of an industrial control system. The classification model may produce a baseline for an industrial control system's behavior.

The contextual intervention model may also include a software update application associated with a particular industrial control system. The software update application may provide a communication link between industrial control system components and network services, including running the classification model. Through an application programming interface, the software update application may further provide an interface for controlling the update that is accessible to a user.

Through the network, classification model, and software update application, the contextual intervention model enables intervention categories to be associated with industrial things, and a score of impact to be calculated. Based on results of the classification queries, an industrial control system update application may provide a report and/or make recommendations to a user device for intervention with a software update.

### BRIEF DESCRIPTION OF THE DRAWINGS

FIG. 1 is a diagram illustrating an exemplary network in which systems and/or methods described herein may be implemented;

FIG. 2 is a flow diagram of an exemplary process for the workflow to be performed by a network device of FIG. 1;

FIG. 3 is diagram of exemplary data received by a network device in FIG. 1;

FIG. 4 is a diagram of exemplary components of a user device of FIG. 1;

FIG. 5 is a flow diagram illustrating an exemplary process for the operation of a network component in FIG. 1; and

FIG. 6 is a block diagram of exemplary components of a device that may correspond to one of the devices of FIG. 1.

### DETAILED DESCRIPTION OF PREFERRED EMBODIMENTS

The following detailed description refers to the accompanying drawings. The same reference numbers in different drawings identify the same or similar elements.

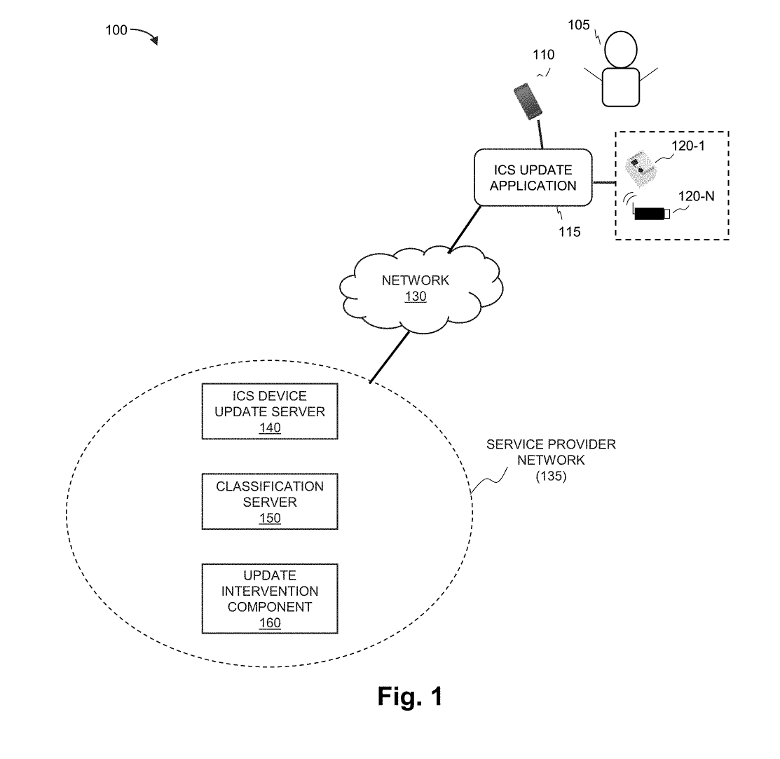

FIG. 1 illustrates an example environment 100 in which systems and/or methods described herein may be implemented. As shown in FIG. 1, environment 100 may include a user 105 associated with a mobile device 110 (e.g., a smartphone) and one or more industrial thing devices 120-1 through 120-N (collectively “industrial thing devices 120” and individually “industrial thing device 120”). Network connectivity may be provided to mobile device 110 via network 130. Mobile device 110 may connect to industrial thing devices 120 using wireless and/or wired connections, such as through a short range wireless connection or using a pluggable, cable connection. Environment 100 may further include a service provider network 135 including ICS device update server 140, classification server 150, and update intervention component 160. Service provider network 105 may include a number of separate networks.

Mobile device 110 may include a portable communication device that is capable of connecting to network 130. Mobile device 110 may include a smartphone, a personal digital assistant (PDA), a laptop computer, a desktop computer, a tablet computer, or another type of computation and communication device. Alternatively, or additionally, mobile device 110 may include a radio interface with a cellular wireless interface designed to connect with network 130. Mobile device 110 may also include additional interfaces to connect to additional devices, such as industrial thing devices 120. The additional interfaces may include a short range radio interface (e.g., Bluetooth®), a WiFi interface, and/or a wired interface (e.g., a USB interface).

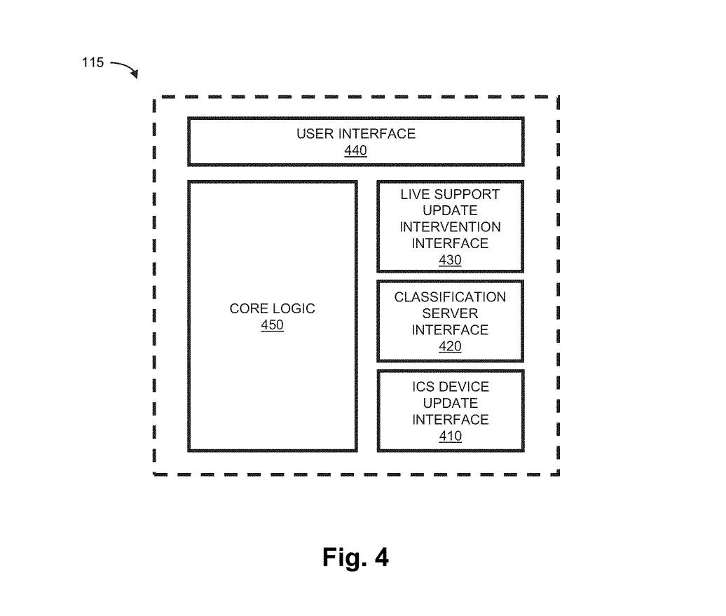

Mobile device 110 may additionally be associated with an application, illustrated as ICS update application 115, designed to function with one or more of industrial thing devices 120. ICS update application 115 may be a user-installed or third-party installed application, such as an application that is installed at mobile device 110 when a user 105 initially connects the mobile device 110 to an industrial thing device 120. ICS update application 115 may generally be used to control the ICS update and/or provide an interface in which data collected by industrial thing devices 120 may be provided to user 105. ICS update application 115 may also act as a communication link between industrial thing devices 120 and services provided through network 130. In some implementations, each industrial thing-specific update application developed by an ICS device update server may be independently developed by the ICS device update server 140, potentially using an application programming interface (API) that is provided by an operator of the classification server 150 and/or by the update intervention component 160. Alternatively, or additionally, an operator of classification server 150 and/or update intervention component 160 may provide a template for an application specific to an industrial thing that may be customized by an ICS device update server 140. ICS update application 115 will be described in more detail below with FIG. 4.

Particular examples of industrial thing devices 120 include but are not limited to: supervisory control and data acquisition (SCADA) systems, distributed control systems (DCS), and other control system configurations such as skid-mounted Programmable Logic Controllers (PLC), and building automation and control systems (BACS), or combinations thereof. Data sensed by industrial thing devices 120 may be transmitted to a mobile device 110.

Network 130 may include one or more networks that provide wireless network connectivity to mobile device 110. For example, the network 130 may represent a wireless network that provides cellular wireless coverage. In some implementations, network 130 may be associated with an evolved packet system (EPS) that includes a Long Term Evolution (LTE) network and/or an evolved packet core (EPC) network that operates based on a Third Generation Partnership Project (3GPP) wireless communication standard. A radio access network (RAN) associated with wireless network 130 may include one or more base stations, some or all of which may take the form of an evolved node B (eNB).

ICS device update server 140 may represent the manufacturer of an industrial thing device 120, a distributor of an industrial thing device 120, or another entity that markets, develops, and/or sells an industrial thing device 120 or related software/services to end-users such as user 105. ICS device update server 140 may develop or publish an ICS update application 115 for use with one or more of industrial thing devices 120. The ICS update application 115 may use classification services provided by classification server 150. For example, ICS device update server 140 may upload initial training data, corresponding to operational behavior sensed by industrial thing devices 120, to server 150. Classification server 150 may perform machine classification operations, such as machine classification based on a supervised or unsupervised learning model, to classify the sensed data as belonging to one or more categories.

Classification server 150 may include one or more computing devices that provides classification services to ICS update applications 115. Although referred to as a “server,” classification server 150 may include a single computing device, clusters of computing devices (e.g., blades or rack-mounted server computers) that are co-located or geographically distributed, cloud-based (e.g., computing as a service) computing solutions, or other arrangements of computing devices.

Update intervention component 160 may represent a grouping of employees to provide live human assistance or guidance to users of ICS update application 115. For example, update intervention component 160 may represent a call center or texting center in which one or more human operators work. As another example, update intervention component 160 may include one or more computing devices to receive requests for textual support, from ICS update application 115, and to transfer the support session to an operator associated with ICS device update server 140.

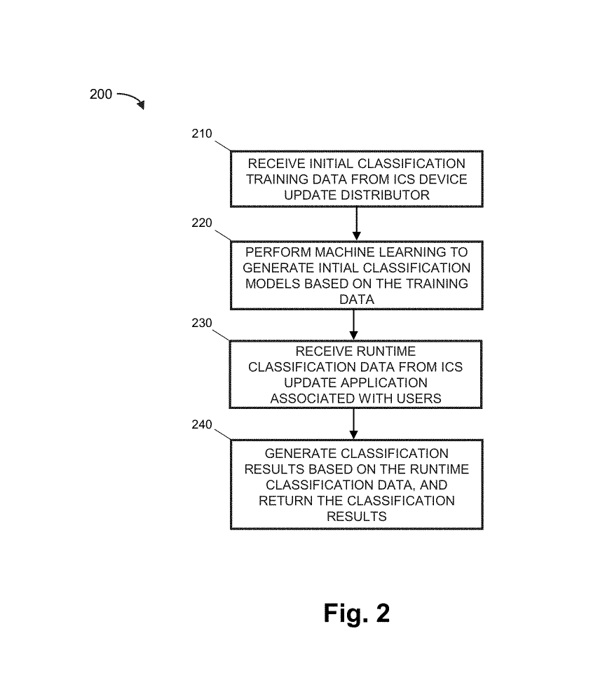

FIG. 2 is a flow chart illustrating an example process 200 relating to the operation of classification server 150 in providing classification services to ICS update application 115.

Process 200 may include receiving initial classification training data from the ICS device update server 140 (block 210). This initial classification data might include a number of labeled classification records where each classification record includes a number of values (e.g., data sensed by industrial thing devices 120, user-entered information, or other information). The initial training data may be generated by ICS device update server 140 as data that the server determines will be similar to actual classification data that is generated by application 115.

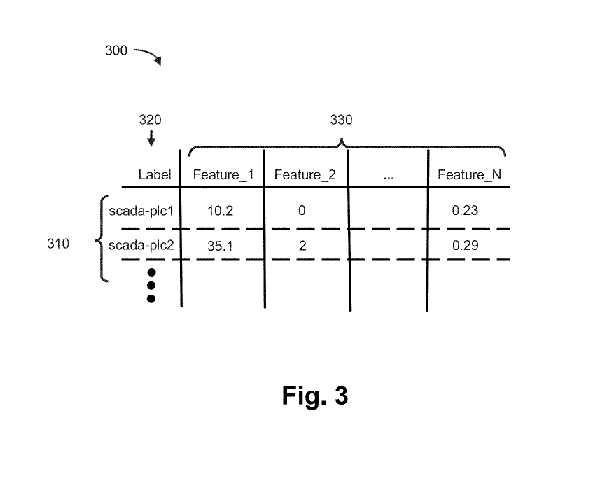

FIG. 3 shows an example of initial training data received in block 210 (FIG. 2). As illustrated, the initial classification training data may include a number of classification records (310). Each classification record in 310 may include a label 320 to identify the record as corresponding to a particular type and one or more feature values (330: illustrated as Feature_1, Feature_2, . . . , Feature_N). In the example illustrated, 310 may comprise of records generated based on data received from SCADA PLC (power plant and automobile assembly line) devices. The records may each correspond to data generated in response to a user focusing the SCADA PLC device on different situations. For example, the first record in 310 (scada-plc1) may correspond to data associated with providing operational control of discrete processes such as power plant soot blower controls, and the second record in 310 may correspond to measurements made by data associated with automobile assembly lines.

In some implementations, each record of the initial classification training data may additionally be associated with a classification result value. For example, the classification record labeled “scada-plc1” within 310 may include an indication of whether the measurements, relating to the power plant soot blower, indicate that the operation is well within normal range, moderately deviant, or poorly compliant.

Returning to FIG. 2, Process 200 may further include classification server 150 performing machine learning techniques to generate initial classification models based on the received initial classification training data (block 220). In an implementation corresponding to the example training data of FIG. 3, a separate classification model may be generated for each differently labeled record. As previously mentioned, the classification models may be generated using a number of supervised or unsupervised learning techniques. The resulting model may have a baseline “compliant” range, with further segments “moderately deviant” and “poorly compliant.”

In some implementations, ICS device update server 140 may define a transform flow describing how data received from a particular ICS update application 115 is to be processed or pre-processed before being used as an input to a classification model. Classification models, generated by classification server 150, may be updated as additional classification data is received from users during the operation of ICS update application 115.

Process 200 may further include receiving runtime classification data from ICS update applications (block 230). The runtime classification data may be data corresponding to sensor data from industrial thing devices 120, collected after potentially processing and/or augmenting the corresponding ICS update application 115. For example, ICS update application 115 may receive data from a number of devices and aggregate this data to form a classification record. The classification record may then be transmitted to classification server 150 as a classification query.

Process 200 may further include generating classification results, based on the runtime classification data (block 240). The generated classification results (e.g., a classification class) may be designated as aberrant if values are in the example classification classes of “moderately deviant” or “poorly compliant” described above. The results may be returned to the application that transmitted the runtime classification data. In some implementations, based on the received runtime classification data, classification server 150 may occasionally or periodically update the classification models. In so doing, the classification models may be updated to take advantage of new user data.

FIG. 4 is a block diagram conceptually illustrating components of ICS update application 115. As illustrated, ICS update application 115 may include ICS device update interface 410, classification server interface 420, live support update intervention interface 430, user interface 440, and core logic 450.

ICS device update interface 410 may include logic to provide an interface to industrial thing devices 120. 410 may, for example, be configured based on a specific industrial thing device 120 for which ICS update application 115 is compatible. Moreover, 410 may generally handle communications with industrial thing devices 120.

Classification server interface 420 may handle communications with classification server 150. 420 may, for example, handle the transmission of classification queries to classification server 150 and the reception of responses.

Live support update intervention interface 430 may handle communications with update intervention component 160. In one implementation, live support sessions (e.g., voice or text chat) may be implemented using voice over LTE (VoLTE) services in network 130. Live support update intervention interface 430 may establish and end the live support sessions.

ICS update application 115 may request contextual support from update intervention component 160 based on ICS update application 115 entering a particular state (such as a state triggered by a classification query to classification server 150). In this situation, ICS update application 115 may present user 105 with a dialog providing the user an option to chat with an operator via a textual or voice interface.

User interface 440 may present a graphical interface to user 105. User interface 440 may provide, for example, instructions to the user on the operation of a particular industrial thing device 120, the ability to control functionality of industrial thing devices 120 (e.g., for a SCADA PLC device control when the device is actively sensing), and furthermore provide feedback and/or display the data sensed by an industrial thing device 120.

Core logic 450 may include functionality relating to the overall control and operation of ICS update application 115. 450 may control the interaction of ICS device update interface 410 with the classification server interface 420, live support update intervention interface 430, and the user interface 440.

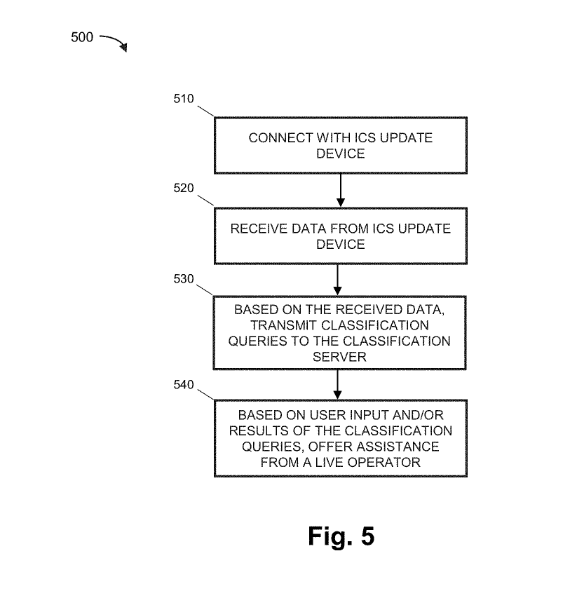

FIG. 5 is a flow chart illustrating an example process 500 relating to the operation of the ICS update application 115 after creation of the classification model.

Process 500 may include connecting with an ICS update device (block 510). In some implementations, as part of the initial connection to an ICS update device, ICS update application 115 may identify the ICS update device and, based on this identification, download or update 115 to include functionality corresponding to the identified ICS update device (e.g., functionality implemented by the corresponding ICS device update server 140).

Process 500 may further include receiving data from the ICS update device (block 520). The data may include data sensed by ICS update application 115. Moreover, in any implementation, 115 may instruct the user on how to control it to obtain useful sensed data. An industrial monitoring and/or inspection application includes, for instance, a SCADA PLC device. 115 may collect data from the sensor stream of industrial thing devices 120 at various structures in the SCADA setup, such as from soot blower data and an assembly line controller's data. The user may indicate at which structure industrial thing devices 120 are pointed and may then initiate recording of the sensed data. In conjunction with data sensed by industrial thing devices 120, ICS update application 115 may control online mobile device 110 to acquire additional data. Both sets of measurements may be used as part of subsequent analysis and/or classification that may be implemented as part of the operation of the SCADA update intervention application.

Based on the data received from the ICS update application device 115, Process 500 may further include transmitting classification queries to the classification server (block 530). As previously mentioned, classification server 150 may provide classification services relating to the operation of industrial thing devices 120. The classification queries may include requests to determine classification categories relating to the operation of ICS update application 115. For example, in the context of a monitoring/inspection application for a power plant soot blower, the classification queries may quantify the amount that a blower in the SCADA setup is impacted (e.g., a blower may be determined to be “well within normal,” “moderately deviant,” “poorly compliant”). Based on results of the classification queries, ICS update application 115 may provide a report and/or make recommendations to user 105.

Process 500 may further include offering contextual assistance from a live operator (block 540). The contextual assistance may be based on user input and/or results of the classification queries. For example, in the context of the power plant soot blower monitoring/inspection application, based on a classification query that indicates that a blower in the SCADA setup is “poorly compliant,” ICS update application 115 may provide a dialogue to the user asking whether the user would like to speak to a live operator that is an expert in blower repair and replacement. If the user chooses to speak to the live operator, 115 may enable, via VoLTE services, for instance, a voice call with the live operator and potentially supplement the voice call with the data obtained by 115 (e.g., the level of deviation from a compliant range).

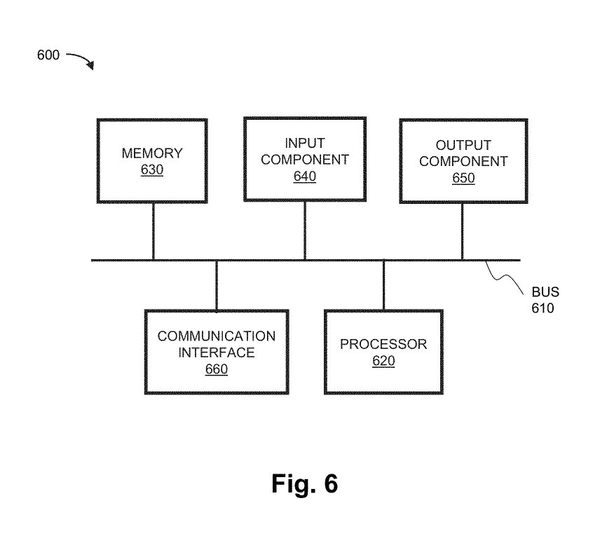

FIG. 6 is a diagram of example components of device 600. One or more of device 600 may in turn be included as components in FIG. 1, such as an industrial thing device 120 or ICS update application 115. Device 600 may include bus 610, processor 620, memory 630, input component 640, output component 650, and communication interface 660. In some other implementation, device 600 may include additional, fewer, different, or differently arranged components.

Bus 610 may include one or more communication paths that permit communication among the components of a device 600. Processor 620 may include a processor, microprocessor, or processing logic that can interpret and execute instructions. Memory 630 may include any type of dynamic storage device that can store information and instructions for execution by processor 620 and/or any type of non-volatile storage device that may store information for use by processor 620.

Input component 640 may include a mechanism that permits an operator to input information to device 600, such as a keyboard, a keypad, a button, or a switch. Output component 650 may include a mechanism that outputs information to the operator such as a display, a speaker, or one or more light emitting diodes (LEDs).

Communication interface 660 may include any transceiver-like mechanism that enables 600 to communicate with other devices and/or systems. For example, communication interface 660 may include an Ethernet interface, an optical interface, a coaxial interface, a radio interface, and other elements. 660 may also include a wireless communication device such as an infrared (“IR”) receiver, a Bluetooth radio, a Wi-Fi radio, a cellular radio, or others of the like. The wireless communication device may also be coupled to an external device such as a remote control, wireless keyboard, mobile telephone, and other such devices. In some embodiments, device 600 may include more than one communication interface 660. For instance, device 600 may include both an optical interface and an Ethernet interface.

Device 600 may perform certain operations relating to one or more processes described above. 600 may perform these operations in response to processor 620 executing software instructions stored in a computer-readable medium, such as memory 630. A computer-readable medium may be defined as a non-transitory memory device. A memory device may include space within a single physical memory device or spread across multiple physical memory devices. The software instructions may be read into memory 630 from another computer-readable medium or from another device. The software instructions stored in 630 may cause processor 620 to perform processes described herein. Alternatively, hardwired circuitry may be used in place of or in combination with software instructions to implement processes described herein. Thus, implementations described herein are not limited to any specific combination of hardware circuitry and software.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

What is claimed is:

1. A method performed by one or more network devices, comprising:
receiving, by a network device, sensor data of industrial control system components to provide a contextual intervention model;
generating, by one of the network devices and based on the received data, a classification model for software update impact evaluation;
receiving, by one of the network devices, runtime data following a software update;
generating, based on the runtime data and classification model, classification results for the received industrial thing data; and
sending, by one of the network devices and to the user device, the classification results.

2. The method of claim 1, wherein the workflow is configured to be presented on the user device via an interactive user interface.

3. The method of claim 1, wherein the classification model includes one of a supervised or unsupervised learning model.

4. The method of claim 1, wherein the classification queries and results are configured to be accessed via an application program interface (API) residing on the user device.

5. The method of claim 1, further comprising:
repeating the workflow to create the classification model,
generating, with network device updates, new classification results for networked industrial things, and
sending new classification results to user devices based on latest data, after network device updates.

6. The method of claim 1, further comprising:
providing, by one of the network devices, intervention service based on the classification results.

7. A system, comprising:
one or more first network devices configured to:
receive training data to evaluate software update impact,
generate, based on the training data, a classification scheme for providing a software update evaluation,
receive user input and runtime data from the user device,
generate classification results for the received data, based on the user input, runtime data, and classification model, and
send, to the user device, the classification results.

8. The system of claim 7, further comprising:
one or more second network devices configured to:
send, to the first network device, training data,
receive, from the first network device, a request to conduct a data transfer, and
send a request to conduct a data transaction, wherein the request includes a network device identifier.

9. The system of claim 7, further comprising:
One or more third network devices configured to:
receive from the second network device, a request to conduct a data transfer,
verify eligibility of the second network device based on the device identifier, and
send, to the first network device, the queried data.

10. A user device comprising:
a network interface to communicate with one or more remote systems;
one or more memories to store instructions; and
one or more processors configured to execute instructions in the one or more memories to:
present a user interface to receive data classification queries to evaluate software update impact,
receive, via the user interface, the classification queries,
transmit the queried data to the classification server, and
receive, from the first network device, an instruction set to address evaluations.
